(19) United States
(12) Patent Application Publication
(10) Pub. No.: US 2015/0070477 A1
(43) Pub. Date: Mar. 12, 2015

(54) IMAGE PROCESSING DEVICE, IMAGE PROCESSING METHOD, AND PROGRAM

(71) Applicant: Sony Corporation, Tokyo (JP)

(72) Inventor: Yuhei Taki, Kanagawa (JP)

(21) Appl. No.: 14/387,365

(22) PCT Filed: Feb. 4, 2013
(86) PCT No.: PCT/JP2013/052459

§ 371 Date: Sep. 23, 2014

(30) Foreign Application Priority Data
Mar. 30, 2012 (JP) 2012-080991

(51) Int. Cl. H04N 13/04

(52) U.S. Cl. CPC H04N 13/0429
USPC 348/56

(57) ABSTRACT

There is provided an image processing device including a determination unit configured to determine whether or not difference between left-eye image data and right-eye image data which constitute image data satisfies a threshold condition, and an adjustment unit configured to adjust the image data in a manner that an angle of convergence become smaller in a case of stereoscopically displaying the image data, in a case where the determination unit determines that the difference satisfies the threshold condition. The adjustment unit adjusts the image data in a manner that respective pieces of image data become a same in movement amount of display positions in a depth direction perceived at a target point, the pieces of image data corresponding to a plurality of frames.

### TECHNICAL FIELD

The present disclosure relates to an image processing device, an image processing method, and a program.

### BACKGROUND ART

Recently, a 3D display device which can cause a user to perceive a stereoscopic image by displaying a left-eye image (L image) and a right-eye image (R image) has been distributed. By using the 3D display device, while the user can obtain an effect that realistic sensation of the user is enhanced, the user easily gets eyestrain. Although there are diverse factors of the eyestrain, the factors include crosstalk occurring from a mixture of L images and R images, and flicker occurring from lack of a refresh rate of a liquid crystal shutter, as examples. Accordingly, a frame rate of a liquid crystal has been improved, and shutter grasses have been improved. However, a matter of the eyestrain has not solved enough.

Moreover, it has been considered that occurrence of the eyestrain depends not only on display types and equipment, but also individual characteristics of a user who views video and a way the user views the video. According to such situation, a guideline for viewing ways and equipment has been issued. For example, 3D Consortium promoting progress of 3D industry by public and private cooperation made a guideline for viewing stereoscopic video and aims to achieve comfortable stereoscopic-image viewing.

In addition, in a case where display is extruded excessively or in a case where change of disparity difference is wide, fatigue of the user becomes severe. From such a standpoint, a technology of comfortable 3D display has been investigated. For example, Patent Literature 1 discloses a disparity conversion device configured to adjust disparity between an L image and an R image by shifting the L image and/or the R image in a horizontal direction.

### CITATION LIST

### Patent Literature

Patent Literature 1: JP 2011-55022A

### SUMMARY OF INVENTION

### Technical Problem

As described above, it has been possible to adjust a position in a depth direction in an image having a large extrusion amount by shifting the L image and/or the R image in a horizontal direction. However, when the position in the depth direction in the image having a large extrusion amount is adjusted, a relative relation with another image at a position in the depth direction is changed.

Accordingly, the present disclosure proposes a novel and improved image processing device, image processing method, and program capable of decreasing fatigue of a user without damaging a relation of a sense of depth of a plurality of stereoscopically-displayed frames.

### Solution to Problem

According to the present disclosure, there is provided an image processing device including a determination unit configured to determine whether or not difference between left-eye image data and right-eye image data which constitute image data satisfies a threshold condition, and an adjustment unit configured to adjust the image data in a manner that an angle of convergence become smaller in a case of stereoscopically displaying the image data, in a case where the determination unit determines that the difference satisfies the threshold condition. The adjustment unit adjusts the image data in a manner that respective pieces of image data become a same in movement amount of display positions in a depth direction perceived at a target point, the pieces of image data corresponding to a plurality of frames.

According to the present disclosure, there is provided an image processing method including determining whether or not difference between left-eye image data and right-eye image data which constitute image data satisfies a threshold condition, adjusting the image data in a manner that an angle of convergence become smaller in a case of stereoscopically displaying the image data, in a case where it is determined that the difference satisfies the threshold condition, and adjusting the image data in a manner that respective pieces of image data become a same in movement amount of display positions in a depth direction perceived at a target point, the pieces of image data corresponding to a plurality of frames.

According to the present disclosure, there is provided a program causing a computer to function as a determination unit configured to determine whether or not difference between left-eye image data and right-eye image data which constitute image data satisfies a threshold condition, and an adjustment unit configured to adjust the image data in a manner that an angle of convergence become smaller in a case of stereoscopically displaying the image data, in a case where the determination unit determines that the difference satisfies the threshold condition. The adjustment unit adjusts the image data in a manner that respective pieces of image data become a same in movement amount of display positions in a depth direction perceived at a target point, the pieces of image data corresponding to a plurality of frames.

### Advantageous Effects of Invention

As described above, according to the present disclosure, fatigue of a user can be decreased without damaging a relation of a sense of depth of a plurality of stereoscopically-displayed frames.

### BRIEF DESCRIPTION OF DRAWINGS

FIG. 1 is an explanatory diagram showing a configuration of a display system according to an embodiment of the present disclosure.

FIG. 2 is an explanatory diagram showing a configuration of a display device according to a first embodiment.

FIG. 3 is an explanatory diagram showing a way of calculating extrusion amount of an image.

FIG. 4 is an explanatory diagram showing a relation between a threshold th and viewing time.

FIG. 5 is an explanatory diagram showing an example of adjusting perceived display positions of 3D video.

FIG. 6 is an explanatory diagram showing that movement amount of a plurality of objects in a depth direction are a same, the plurality of objects being included in a single frame.

FIG. 7 is an explanatory diagram showing that movement amount of respective objects in a depth direction are a same, the respective objects corresponding to a plurality of frames.

FIG. 8 is a flowchart showing operation of a display device according to the first embodiment.

FIG. 9 is an explanatory diagram showing a specific example of a notification window.

FIG. 10 is an explanatory diagram showing another notification example of presence or absence of adjustment.

FIG. 11 is an explanatory diagram showing a configuration of a display device according to a second embodiment.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

Also, in the present specification and the drawings, different letters are sometimes suffixed to the same reference signs to distinguish a plurality of constituent elements having substantially the same functional configuration from each other. However, when it is not necessary to distinguish the plurality of constituent elements having substantially the same functional configuration, only the same reference signs are given.

Note that the present disclosure will be explained in the following order.

### 1. Fundamental Configuration of Display System

### 2. First Embodiment

2-1. Configuration of Display Device according to First Embodiment
2-2. Operation of Display Device according to First Embodiment

### 2-3. Supplemental Remarks

### 3. Second Embodiment

### 4. Conclusion

### 1. Fundamental Configuration of Display System

A technology according to the present disclosure may be performed in various forms as described in detail in “2. First Embodiment” to “3. Second Embodiment” as examples. A display device 100 which is according to each embodiment and which has functions as a display control device includes:

A. a determination unit (adjustment-necessity determination unit 124) configured to determine whether or not difference between left-eye image data and right-eye image data which constitute image data satisfies a threshold condition; and

B. an adjustment unit (display control unit 132) configured to adjust the image data in a manner that an angle of convergence become smaller in a case of stereoscopically displaying the image data, in a case where the determination unit determines that the difference satisfies the threshold condition.

The adjustment unit (display control unit 132) adjusts the image data in a manner that respective pieces of image data become a same in movement amount of display positions in a depth direction perceived at a target point, the pieces of image data corresponding to a plurality of frames.

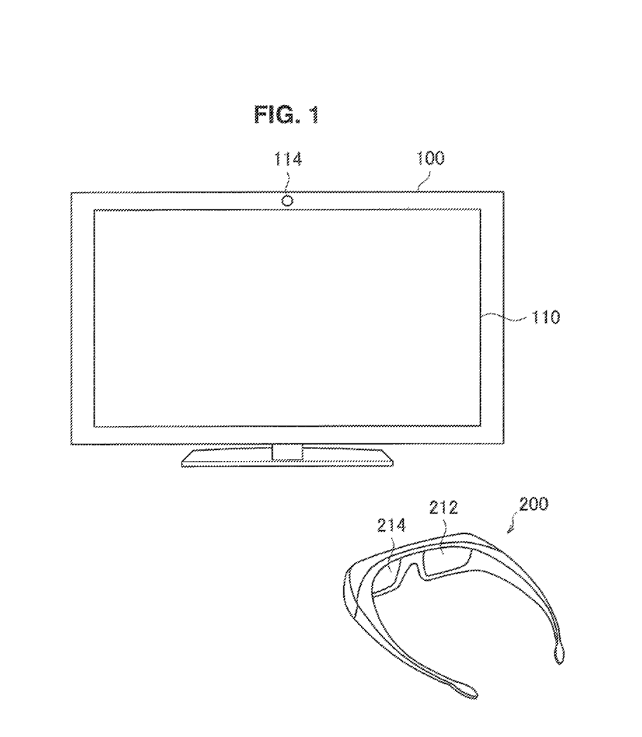

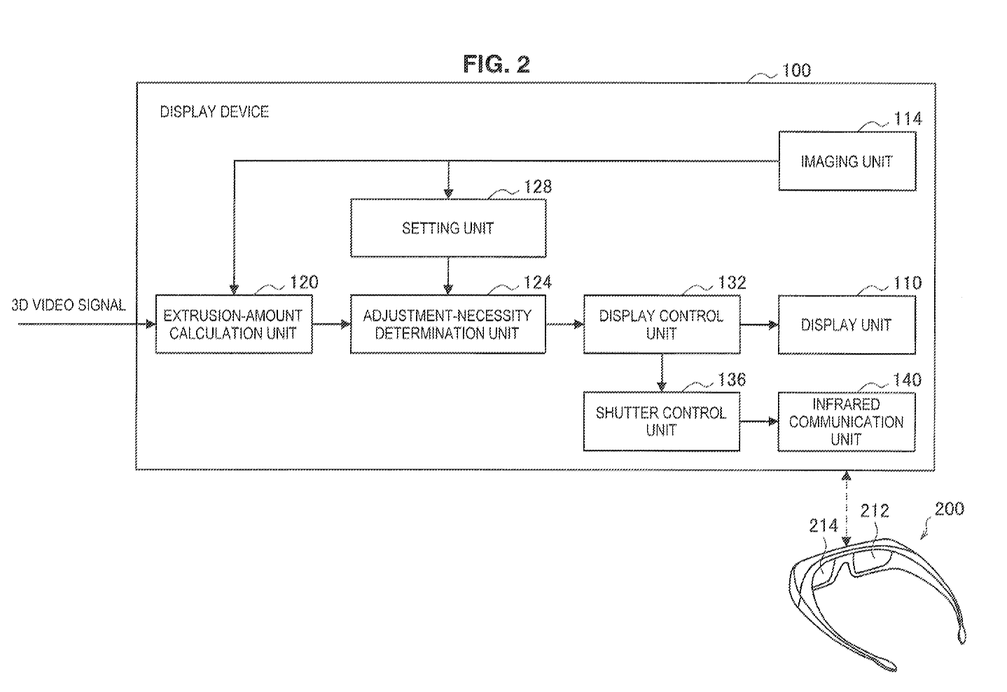

First, with reference to FIG. 1 and FIG. 2, a fundamental configuration of a display system which is common to each embodiment will be described as follows.

FIG. 1 is an explanatory diagram showing a configuration of a display system according to an embodiment of the present disclosure. As shown in FIG. 1, the display system according to the embodiment of the present disclosure includes a display device 100 and shutter glasses 200.

As shown in FIG. 1, the display device 100 includes a display unit 110 on which an image is displayed. The display device 100 can cause a user to perceive a stereoscopic image (3D image) by displaying a left-eye image (L image) and a right-eye image (R image) on the display unit 110. In addition, the display device 100 includes an imaging unit 114 for imaging a range from which the display device 100 can be viewed. By analyzing a captured image obtained by the imaging unit 114, it is possible to recognize a user who views the display device 100.

The shutter glasses 200 include a right-eye image transparent unit 212 and a left-eye image transparent unit 214 which are composed of a liquid crystal shutter, for example. The shutter glasses 200 performs open/close operation on the right-eye image transparent unit 212 and the left-eye image transparent unit 214 in response to a signal transmitted from the display device 100. The user can perceive, as a 3D image, the left-eye image and the right-eye image that are displayed on the display unit 110 by seeing light radiated from the display unit 110 through the right-eye image transparent unit 212 and the left-eye image transparent unit 214 of the shutter glasses 200.

FIG. 1 shows the display device 100 as an example of the image processing device. However, the image processing device is not limited thereto. For example, the image processing device may be an information processing apparatus such as a personal computer (PC), a household video processing apparatus (a DVD recorder, a video cassette recorder, and the like), a personal digital assistant (PDA), a household game device, a cellular phone, a portable video processing apparatus, or a portable game device. Alternatively, the display control device may be a display installed at a theater or in a public space.

In addition, the present specification explains a control method using shutter operation so as to a left-eye image is perceived by a left eye and a right-eye image is perceived by a right eye. However, the control method is not limited thereto. For example, similar effect can be obtained by using a polarization filter for the left eye and a polarization filter for the right eye.

### (Background)

However, in a general display device having a 3D display function, fatigue of a user becomes severe in a case where display is extruded excessively or in a case where change of disparity is wide. From such a standpoint, a technology of comfortable 3D display has been investigated. For example, the technology of adjusting disparity between an L image and an R image by shifting the L image and/or the R image in a horizontal direction has been known. Moreover, it has been considered that occurrence of the eyestrain depends not only on display types and equipment, but also individual characteristics of a user who views video and a way the user views the video. According to such situation, a guideline for viewing ways and equipment has been issued. For example, 3D Consortium promoting progress of 3D industry by public and private cooperation made a guideline for viewing stereoscopic video and aims to achieve comfortable stereoscopic-image viewing.

As described above, by adjusting disparity or by devising viewing ways, it is possible to improve a certain amount of fatigue of the user. However, even if the disparity has been adjusted and the viewing ways have been devised, the fatigue of the user increases as time for viewing 3D-displayed video becomes longer. In addition, when the position in the depth direction in the image having a large extrusion amount is adjusted, a relative relation with another image at a position in the depth direction is changed.

Accordingly, with the above circumstance taken into point of view, the display device 100 according to respective embodiments of the present disclosure has been achieved. The display device 100 according to the respective embodiments of the present disclosure can decrease fatigue of a user without damaging a relation of a sense of depth of a plurality of stereoscopically-displayed frames. Hereinafter, there is subsequently and specifically described the display device 100 according to the respective embodiments of the present disclosure.

### 2. First Embodiment

### 2-1. Configuration of Display Device According to First Embodiment

FIG. 2 is an explanatory diagram showing a configuration of the display device 100 according to a first embodiment. As shown in FIG. 2, the display device 100 according to the first embodiment includes a display unit 110, an imaging unit 114, an extrusion-amount calculation unit 120, an adjustment-necessity determination unit 124, a setting unit 128, a display control unit 132, a shutter control unit 136, and an infrared communication unit 140. Since the description is made in “1. Fundamental Configuration of Display System,” the repeated descriptions of the display unit 110 and the imaging unit 114 will be omitted hereafter.

### (Extrusion-Amount Calculation Unit)

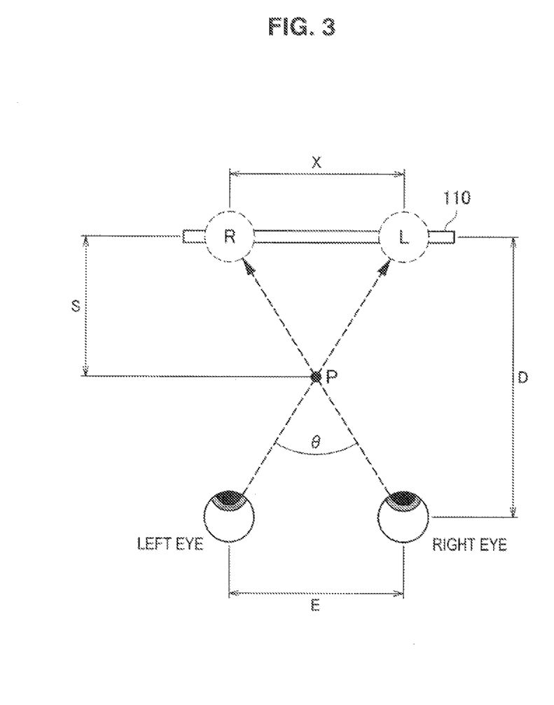

To the extrusion-amount calculation unit 120, a 3D video signal including image data composed of L image data and R image data is input. The 3D video signal may be a received video signal or a video signal read out from a storage medium. The extrusion-amount calculation unit 120 evaluates difference between the L image data and the R image data that are included in the 3D video signal. For example, the extrusion-amount calculation unit 120 calculates extrusion amount from the display unit 110 to a position at which the user perceives that an image exists when 3D display is performed on the basis of the L image data and the R image data. With reference to FIG. 3, a specific example of a way of calculating the extrusion amount will be explained hereinafter.

FIG. 3 is an explanatory diagram showing a way of calculating extrusion amount of an image. As shown in FIG. 3, when an R image and an L image are displayed at different positions on the display unit 110, the user perceives that an image exists at an intersection (hereinafter, perception position P) between a line connecting the right eye and the R image and a line connecting the left eye and the L image.

By using an interval E between the left eye and the right eye of the user, a distance D between the user and the display unit 110, and difference X between the L image and the R image that are shown in FIG. 3, a distance between the perception position P and the display unit 110, that is, extrusion amount S of the perception position P from the display unit 110 is calculated in accordance with the following numerical formula, for example.

Extrusion Amount S=D×X/(X+E)

Note that, the interval E between the left eye and the right eye of the user and the distance D between the user and the display unit 110 can be estimated from a captured image acquired by the imaging unit 114. Alternatively, the interval E between the left eye and the right eye of the user and the distance D between the user and the display unit 110 may be values set in advance.

Note that, the difference X between the L image and the R image can be identified using diverse ways. For example, the extrusion-amount calculation unit 120 can identify the difference X by using a stereo matching method of extracting feature points in the L image and the R image and measuring gaps between the feature points. More specifically, the stereo matching method includes a feature-based method and an area-based method. The feature-based method extracts edges in an image on the basis of brightness values, extracts edge strengths and edge directions as feature points, and measures gaps between similar edge points. The area-based method analyses a degree of matching of patterns for every certain image area, and measures gaps between similar image areas.

Note that, the example in which the extrusion amount is the distance between the perception point P and the display unit 110 has been explained in the above description. However, the present embodiment is not limited thereto. For example, an angle of convergence θ shown in FIG. 3 may be used as the extrusion amount. Note that, the extrusion-amount calculation unit 120 may divide a 3D video signal for unit time and may calculate an average of the extrusion amount in a section.

### (Adjustment-Necessity Determination Unit)

When 3D display is performed on the basis of a 3D video signal, the adjustment-necessity determination unit 124 determines whether or not convergence movement which is uncomfortable for the user occurs. In a case where it is determined that the uncomfortable convergence movement occurs, the adjustment-necessity determination unit 124 instructs the display control unit 132 to adjust extrusion amount.

More specifically, when the 3D display is performed, the adjustment-necessity determination unit 124 determines whether or not the uncomfortable convergence movement occurs on the basis of extrusion amount S calculated by the extrusion-amount calculation unit 120. Here, it is considered that stereoscopic effect increases as the extrusion amount S calculated by the extrusion-amount calculation unit 120 becomes bigger.

Moreover, when viewing stereoscopic video, the convergence movement (cross-eyed state) occurs on the eyes. Accordingly, the user can obtain a sense of depth. However, in a case where the stereoscopic video is extremely extruded, uncomfortable convergence movement which does not occur in a usual life circumstance occurs. It has been considered that such uncomfortable convergence movement is one of causes of eyestrain.

Accordingly, in a case where the extrusion amount S calculated by the extrusion-amount calculation unit 120 is greater than or equals to a threshold th set by the setting unit 128 described later, the adjustment-necessity determination unit 124 instructs the display control unit 132 to adjust the extrusion amount.

### (Setting Unit)

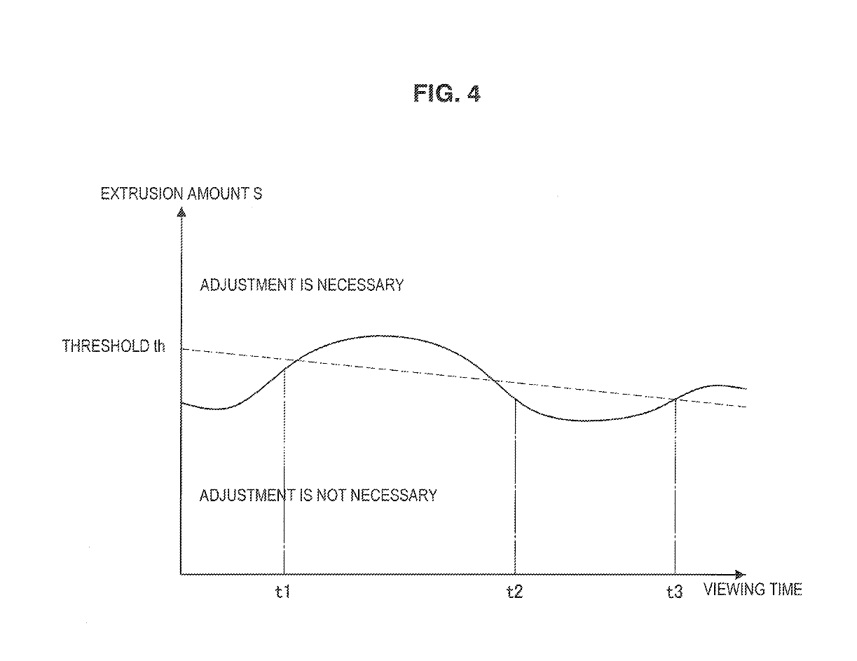

The setting unit 128 sets the threshold th used by the adjustment-necessity determination unit 124 for determining a display type. For example, in a case where viewing time of the user becomes longer, it is considered that the user accumulates fatigue. Accordingly, the setting unit 128 may lower the threshold th as the viewing time of the user becomes longer. In such a configuration, it is possible to increase frequency of extrusion-amount adjustment in a case where the viewing time of the user becomes longer. With reference to FIG. 4, specific examples will be given as follows.

FIG. 4 is an explanatory diagram showing a relation between a threshold th and viewing time. As shown in FIG. 4, the setting unit 128 may continuously decrease the threshold th as the viewing time becomes longer. In an example in FIG. 4, since extrusion amount S in t1 to t2 falls below the threshold th, extrusion-amount adjustment is not performed in t1 to t2. However, near t3 where extrusion amount S is relatively low and where the extrusion-amount adjustment is not performed if the threshold th remains the initial value, since extrusion amount S exceeds the decreased threshold th, the extrusion-amount adjustment is performed. As described above, by continuously decreasing the threshold th as the viewing time becomes longer, it becomes easy to perform extrusion-amount adjustment. Accordingly, it is possible to decrease eyestrain of the user.

Note that, the threshold th which decreases in accordance with the viewing time may be a value obtained by multiplying an initial value by a rate inversely proportional to the viewing time.

Note that, the way of setting a threshold th is not limited to the above-described way using viewing time. For example, since it has been worried about effect of 3D video having an extremely-large extrusion amount to visual function development of a child user, the setting unit 128 may determine whether a user is an adult or a child, and in a case where the user is a child, the setting unit 128 may set the threshold th at a lower value than a case where the user is an adult. Note that, it is possible to estimate whether the user is an adult or a child on the basis of a captured image acquired by the imaging unit 114.

Alternatively, the setting unit 128 may set the threshold value by considering video additional information (for example, a genre of the video and duration) included in a 3D video signal, input from a sensor capable of acquiring a viewing environment, information (eyesight, wearing contacts or glasses, age, distance between eyes) about a living body of the user, a type (a portable device, s stationary device, a screen) of the display device 100 or the like. In addition, the setting unit 128 may set the threshold th at a value designated by the user in accordance with user operation.

### (Display Control Unit)

The display control unit 132 functions as an adjustment unit configured to adjust image data (L image and/or R image) displayed on the display unit 110 in accordance with necessity or unnecessity for adjustment instructed by the adjustment-necessity determination unit 124. Specifically, in a case where the adjustment-necessity determination unit 124 issues an instruction that the adjustment is necessary, the display control unit 132 (adjustment unit) adjusts the image data in a manner that an angle of convergence become smaller (extrusion amount becomes smaller) when the 3D video is viewed. That is, the display control unit 132 (adjustment unit) adjusts the image data in a manner that a display position of an image (object) of the 3D video moves in a depth direction. For example, the display control unit 132 (adjustment unit) moves the display position of the image (object) of the 3D video in the depth direction by performing control in a manner that difference between an L image and an R image becomes smaller.

In addition, the display control unit 132 (adjustment unit) calculates movement amount in a manner that extrusion amount of an image having a largest angle of convergence, that is, having a largest extrusion amount among the respective pieces of the image data becomes less than or equals to the reference value (threshold th).

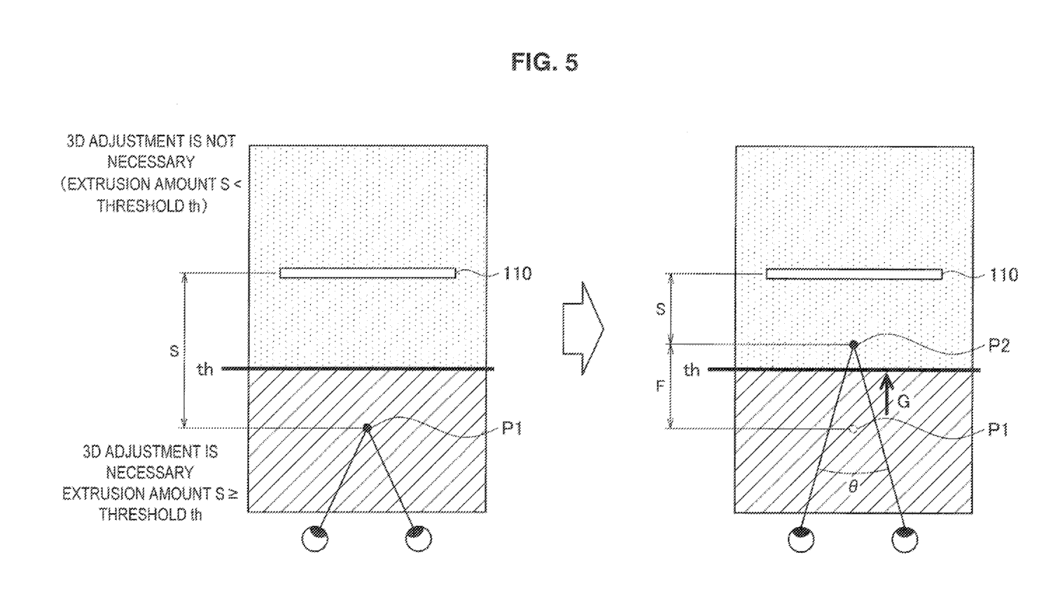

Here, with reference to FIG. 5, the adjustment performed by the display control unit 132 will be specifically explained. FIG. 5 is an explanatory diagram of adjustment performed by the display control unit 132. As shown in the left side of FIG. 5, the adjustment-necessity determination unit 124 determines that the adjustment is necessary, in a case where extrusion amount S from the display unit 110 at a position P1 where the user perceives that an image exists when 3D display is performed on the basis of L image data and R image data exceeds the threshold th. In this case, as shown in the right side of FIG. 5, the display control unit 132 adjust the image data (L image and/or R image) in a manner that the position P1 perceived by the user moves in a depth direction G.

Alternatively, the display control unit 132 may adjust the image data in a manner that the position P1 perceived by the user moves to, for example, a position P2 where the extrusion amount S become smaller than the threshold th to be a criterion for determination of the adjustment necessity. In the example shown in the right side of FIG. 5, the display control unit 132 performs adjustment in a manner that the position P1 perceived by the user moves through movement amount F in the depth direction G.

As described above, by causing the position P1 perceived by the user to move in the depth direction G, an angle of convergence θ becomes smaller, and cross-eyed state of the user is eased. Accordingly, fatigue is decreased.

The example shown in FIG. 5 shows movement of the single position P in the depth direction G However, it is also possible that a plurality of images (objects) are included in 3D video and each of the objects has different extrusion amount S. In this case, the adjustment-necessity determination unit 124 may determine adjustment necessity on the basis of extrusion amount S at a most-extruded position, for example.

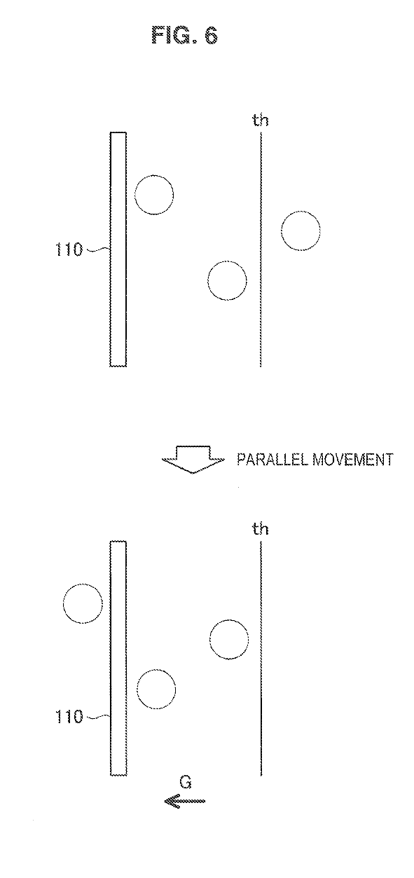

Subsequently, as shown in FIG. 6, the display control unit 132 adjusts an image data in a manner that extrusion amount S of an object having a largest extrusion amount among a plurality of objects included in a single frame falls below the threshold th, and in a manner that movement amount of the plurality of objects become a same. In this way, parallel movement is performed in a manner that the movement amount of the plurality of object in the depth direction G becomes the same. Accordingly, eyestrain of a user can be decreased without damaging a relation of a sense of depth of a plurality of objects included in a single frame of 3D image.

In addition, the display control unit 132 according to the present embodiment adjust image data (L image and/or R image) in a manner that movement amount of respective images (objects) corresponding to a plurality of frames at display positions in the depth direction G become a same.

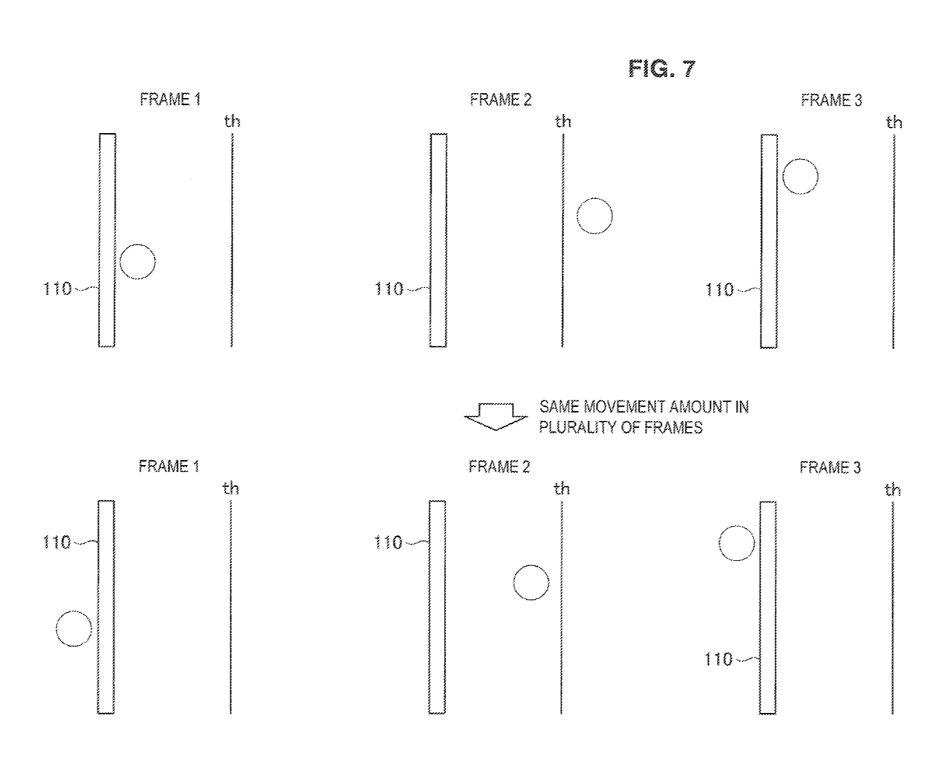

For example, as shown in FIG. 7, the adjustment-necessity determination unit 124 determines that adjustment is necessary in a case where extrusion amount S of at least an object (object in frame 2 in FIG. 7) among a plurality of perceived objects respectively according to frames 1 to 3 exceeds the threshold th.

Next, as shown in FIG. 7, the display control unit 132 adjusts an L image and an R image which constitute each frame in a manner that movement amount of a plurality of perceived objects respectively according to frames 1 to 3 at display positions in a depth direction become a same. Note that, as described above, the movement amount here means difference between a display position of an object (object in frame 2 in the example in FIG. 7) having a largest extrusion amount and a goal display position where the extrusion amount S of the object falls below the threshold th.

In this way, by conforming movement amount of each object corresponding to each of a plurality of frames at a 3D display position in a depth direction G, the display control unit 132 can reduce fatigue of the user without damaging a relation of a sense of depth of a plurality of 3D-displayed frames.

Note that, the display control unit 132 may change movement amount in a depth direction for every object in a frame, in a range where a relation of a sense of depth of 3D display is not damaged.

### (Shutter Control Unit and Infrared Communication Unit)

The shutter control unit 136 generates a shutter control signal for controlling shutter operation of the shutter glasses 200. In the shutter glasses 200, open/close operation of the right-eye image transparent unit 212 and the left-eye image transparent unit 214 is performed on the basis of the shutter control signal generated by the shutter control unit 136 and emitted from the infrared communication unit 140. Specifically, the shutter operation is performed in a manner that the left-eye image transparent unit 214 opens while the left-eye image is displayed on the display unit 110 and the right-eye image transparent unit 212 opens while the right-eye image is displayed on the display unit 110.

### 2-2. Operation of Display Device According to First Embodiment

The configuration of the display device 100 according to the first embodiment has been explained. Next, with reference to FIG. 6, operation of the display device 100 according to the first embodiment will be described.

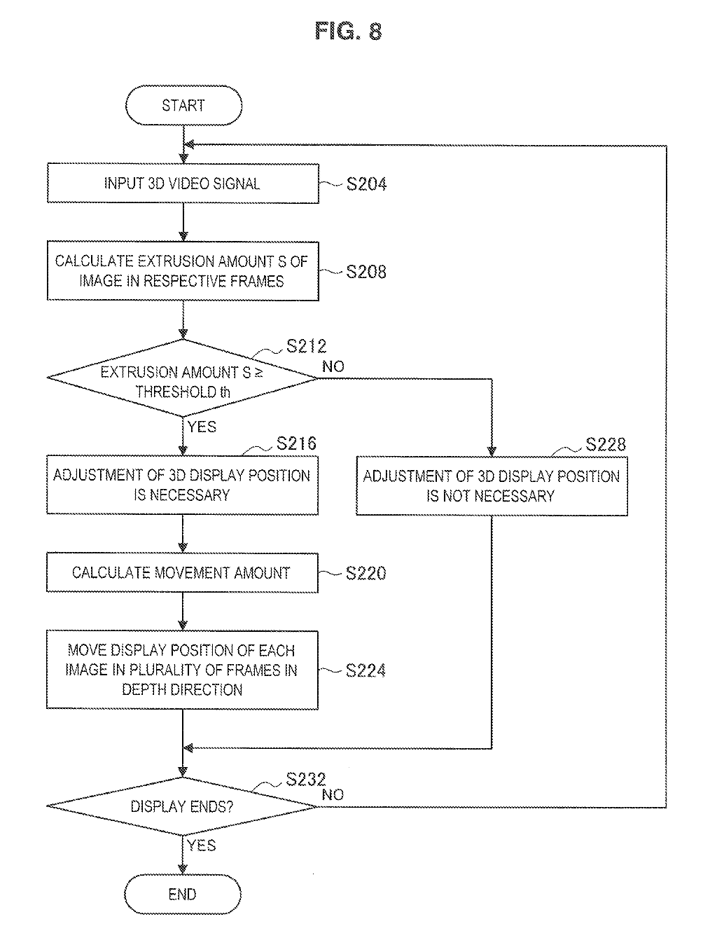

FIG. 8 is a flowchart showing operation of the display device 100 according to the first embodiment. As shown in FIG. 8, a 3D video signal is first input to the extrusion-amount calculation unit 120 (S204). Subsequently, on the basis of L image data and R image data included in the 3D video signal, the extrusion-amount calculation unit 120 calculates extrusion amount S of an image in a case where 3D display is performed (S208). Note that, the extrusion-amount calculation unit 120 in the present embodiment calculates extrusion amount S of each image data in an arbitrary unit time or in an arbitrary number of frames.

Next, the adjustment-necessity determination unit 124 determines whether or not the extrusion amount S calculated by the extrusion-amount calculation unit 120 is greater than or equals to a threshold th set by the setting unit 128 (S212). Subsequently, in a case where the extrusion amount S is less than the threshold th set by the setting unit 128 (NO in step S212), the adjustment-necessity determination unit 124 determines that adjustment of a 3D display position (position perceived by the user) is not necessary (S228).

On the other hand, in a case where the extrusion amount S is greater than or equals to the threshold th (YES in step S212), the adjustment-necessity determination unit 124 determines that adjustment of the 3D display position is necessary and instructs the display control unit 132 to perform adjustment (S216).

In this way, the display control unit 132 calculates movement amount at a 3D display position in a depth direction (S220). As described above, the movement amount means difference between a display position of an object having a largest extrusion amount among a plurality of frames and a goal display position where the extrusion amount S of the object falls below the threshold th.

Subsequently, the display control unit 132 adjusts the image data in a manner that movement amount of respective images (objects) in a plurality of frames at display positions in a depth direction become a same (S224).

Subsequently, the display device 100 repeats the processing of S204 to S228 until display based on the 3D video signal ends (S232).

### 2-3. Supplemental Remarks

The configuration and the operation of the display device 100 according to the first embodiment of the present disclosure have been explained. Hereinafter, supplemental remarks about the first embodiment will be described.

### (Notification of Presence or Absence of Adjustment)

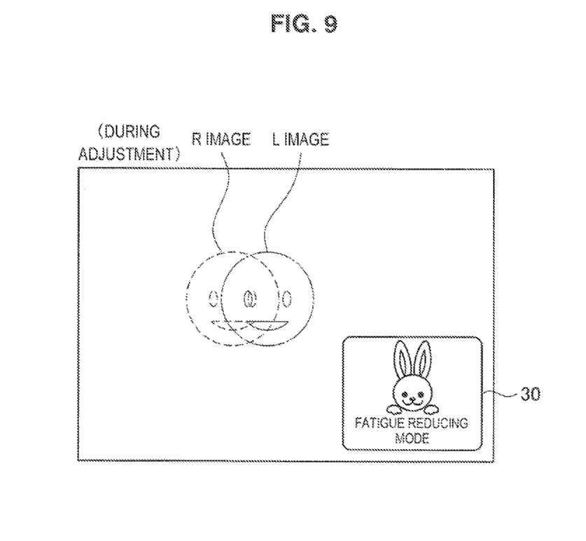

The display control unit 132 may overlay a notification window for notifying the user of presence or absence of 3D-video-signal adjustment. With reference to FIG. 9, specific examples will be given as follows.

FIG. 9 is an explanatory diagram showing a specific example of a notification window. As shown in FIG. 9, in a case where the 3D-video-signal adjustment has been performed, a notification window 30 includes text showing “FATIGUE REDUCING MODE” and a character image which gives a user a gentle impression. The display control unit 132 may perform control in a manner that the notification window 30 is displayed for a certain time when the 3D-video-signal adjustment starts.

On the basis of such a notification window 30, the user can easily recognize that 3D video which is currently displayed has been adjusted for reducing the fatigue.

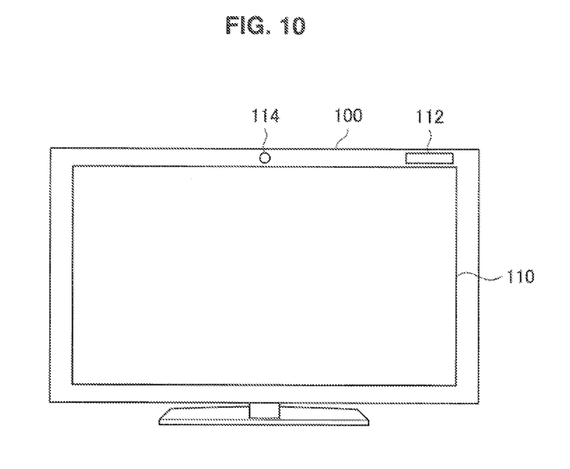

Note that, the notification way of presence or absence of adjustment is not limited thereto. For example, as shown in FIG. 10, it may be possible that a light-emitting unit 112 is provided on a front surface of the display device 100 and the light-emitting unit 112 emits light in a case of performing the 3D-video-signal adjustment. In such a configuration, the user can be notified of presence or absence of adjustment without disturbing viewing of a content image displayed on the display unit 110.

### (Control Based on Gaze of User)

While 3D display is performed on the display device 100, attention of the user may be shifted to another device such as a mobile device. In this period, flicker occurs when the user sees the another device if the shutter operation of the shutter glasses 200 continues. In addition, there is little significance of performing the 3D display on the display device 100 while the user does not see the display device 100.

Accordingly, the shutter control unit 136 may stop the shutter operation of the shutter glasses 200 in a case where the attention of the user wanders from the display device 100. Note that, it is possible to determine whether the attention of the user wanders from the display device 100 by recognizing gaze of the user from the captured image acquired by the imaging unit 114. In such a configuration, the user can use the another device comfortably without taking off the shutter glasses 200.

In addition, the display control unit 132 may stop 3D display on the display unit 110 in a case where the attention of the user wanders from the display device 100. Moreover, the display device 100 may turn off a power supply of the display device 100 in the case where the attention of the user wanders from the display device 100. In such a configuration, it is possible to reduce power consumption of the display device 100.

### 3. Second Embodiment

The first embodiment of the present disclosure has been explained. Next, a second embodiment of the present disclosure will be explained.

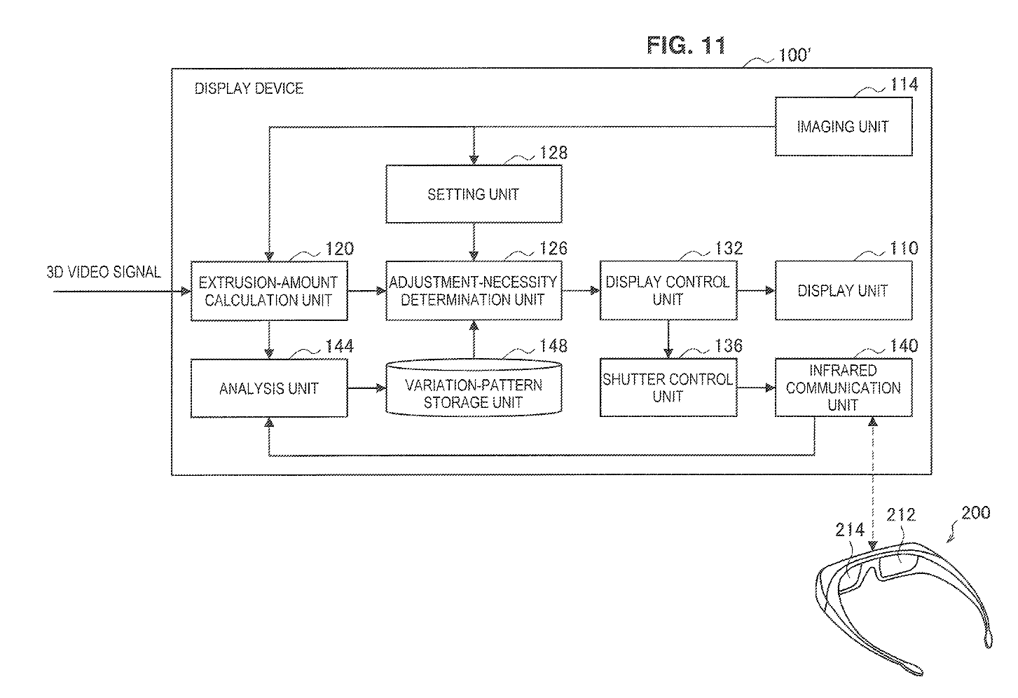

FIG. 11 is an explanatory diagram showing a configuration of a display device 100′ according to a second embodiment. As shown in FIG. 11, the display device 100′ according to the second embodiment includes a display unit 110, an imaging unit 114, an extrusion-amount calculation unit 120, an adjustment-necessity determination unit 126, a setting unit 128, a display control unit 132, a shutter control unit 136, an infrared communication unit 140, an analysis unit 144, and a variation-pattern storage unit 148. Since the description is made in “2. First Embodiment,” the repeated descriptions of the display unit 110, the imaging unit 114, the extrusion-amount calculation unit 120, the setting unit 128, the display control unit 132, and the shutter control unit 136 will be omitted hereinafter.

The display device 100′ according to the second embodiment acquires biological information of a user such as pulses and movement of mimic muscles from a user using device. For example, the shutter glasses 200 worn by the user acquires biological information of the user, and the infrared communication unit 140 receives the biological information of the user from the shutter glasses 200.

On the basis of changes in the biological information of the user, the analysis unit 144 analyses an image pattern which causes the user to get fatigue. For example, in a case where the biological information of the user indicates that the user gets fatigue, the analysis unit 144 analyses a variation pattern of difference (that is, variation pattern of extrusion amount) between an L image and an R image that are displayed when the biological information is acquired. Subsequently, the variation-pattern storage unit 148 stores the variation pattern acquired from the analysis performed by the analysis unit 144. For example, the variation pattern includes a pattern in which an increase and decrease of the extrusion amount is repeated three times in a unit period.

The adjustment-necessity determination unit 126 determines whether a variation pattern of extrusion amount calculated by the extrusion-amount calculation unit 120 matches with a variation pattern stored in the variation-pattern storage unit 148. Here, in a case where the variation pattern of the extrusion amount calculated by the extrusion-amount calculation unit 120 matches with the variation pattern stored in the variation-pattern storage unit 148, it is considered that the 3D display causes the user to get fatigue. Accordingly, in the case where the variation pattern of the extrusion amount calculated by the extrusion-amount calculation unit 120 matches with the variation pattern stored in the variation-pattern storage unit 148, the adjustment-necessity determination unit 126 instructs the display control unit 132 to adjust image data.

According to the above-described second embodiment, it is possible to automatically generate an adjustment-necessity determination condition tailored to an individual user on the basis of biological information of the user acquired while the user views a 3D image, and it is also possible to determine the necessity of adjustment according to the adjustment-necessity determination condition.

### 4. Conclusion

As described above, according to the embodiments of the present disclosure, a display position (position perceived by the user) of 3D video can be moved in a depth direction. Accordingly, uncomfortable convergence movement can be suppressed and eyestrain of the user can be reduced. In addition, according to the embodiments of the present disclosure, respective objects corresponding to a plurality of frames are moved in a parallel manner. Accordingly, fatigue of the user can be reduced without damaging a relation of a sense of depth of respective 3D-displayed objects corresponding to a plurality of frames.

Moreover, according to the embodiments of the present disclosure, power consumption can be reduced since unnecessary 3D display or driving of shutter glasses can be suppressed by estimating a gaze direction of the user. Further, according to the embodiments of the present disclosure, it is possible to automatically generate a determination condition of presence or absence of adjustment tailored to an individual user on the basis of biological information of the user acquired while the user views 3D video, and it is also possible to determine the presence or absence of adjustment in accordance with the determination condition.

In addition, the eyestrain of the user from the excessively-extruded 3D display can be decreased. Accordingly, it is possible to impress a user who concerns about bad effect of the 3D display with attractions of the 3D display. In this way, the embodiments of the present disclosure can contribute the progress of 3D industry.

The preferred embodiments of the present disclosure have been described above with reference to the accompanying drawings, whilst the present disclosure is not limited to the above examples, of course. A person skilled in the art may find various alterations and modifications within the scope of the appended claims, and it should be understood that they will naturally come under the technical scope of the present invention.

For example, it may not be necessary to chronologically execute respective steps in the processing, which is executed by the display device 100 according to this specification, in the order described in the flowchart. For example, the respective steps in the processing which is executed by display device 100 may be processed in the order different from the order described in the flow charts, and may also be processed in parallel.

Further, a computer program for causing hardware, such as a CPU, ROM and RAM built into the display device 100 to exhibit functions the same as each of the elements of the above described display device 100 can be created. Further, a storage medium on which this computer program is recorded can also be provided.

Additionally, the present technology may also be configured as below.

(1)

An image processing device including:

a determination unit configured to determine whether or not difference between left-eye image data and right-eye image data which constitute image data satisfies a threshold condition; and

an adjustment unit configured to adjust the image data in a manner that an angle of convergence become smaller in a case of stereoscopically displaying the image data, in a case where the determination unit determines that the difference satisfies the threshold condition,

wherein the adjustment unit adjusts the image data in a manner that respective pieces of image data become a same in movement amount of display positions in a depth direction perceived at a target point, the pieces of image data corresponding to a plurality of frames.

(2)

The image processing device according to (1),

wherein the adjustment unit calculates the movement amount in a manner that extrusion amount of image data having a largest angle of convergence among the respective pieces of image data falls below a reference value.

(3)

The image processing device according to (2),

wherein, as the threshold condition, the determination unit determines whether or not to satisfy a condition that extrusion amount according to the difference between the left-eye image data and the right-eye image data is greater than or equals to the reference value.

(4)

The image processing device according to any one of (1) to (3), further including:

a setting unit configured to set the threshold condition.

(5)

The image processing device according to (4),

wherein the setting unit sets the threshold condition on the basis of continuous use time of a display device by a user of the display device, the display device performing display using the image data.

(6)

The image processing device according to (5),

wherein the setting unit widens a range of the difference satisfying the threshold condition as the continuous use time becomes longer.

(7)

The image processing device according to any one of (4) to (6),

wherein the setting unit sets the threshold condition on the basis of an attribute of a user of a display device performing display using the image data.

(8)

The image processing device according to (7),

wherein, in a case where the user is a child, the setting unit widens a range of the difference satisfying the threshold condition more than the range of the difference satisfying the threshold condition in a case where the user is an adult.

(9)

The image processing device according to (4),

wherein the setting unit sets the threshold condition in accordance with user operation.

(10)

The image processing device according to (1), further including:

a storage unit configured to store a specific variation pattern of the difference,

wherein the determination unit further determines whether or not a variation pattern of difference between left-eye image data and right-eye image data of target image data matches with the specific variation pattern stored in the storage unit, and

wherein the adjustment unit adjusts the image data in a case where the determination unit determines that the difference satisfies the threshold condition and determines that the variation pattern of the target image data matches with the specific variation pattern.

(11)

The image processing device according to (10), further including:

an analysis unit configured to analyze left-eye image data and right-eye image data of image data to which biological information of a user shows a specific reaction when stereoscopic display is performed, and then extract the specific variation pattern.

(12)

An image processing method including:

determining whether or not difference between left-eye image data and right-eye image data which constitute image data satisfies a threshold condition;

adjusting the image data in a manner that an angle of convergence become smaller in a case of stereoscopically displaying the image data, in a case where it is determined that the difference satisfies the threshold condition; and

adjusting the image data in a manner that respective pieces of image data become a same in movement amount of display positions in a depth direction perceived at a target point, the pieces of image data corresponding to a plurality of frames.

(13)

A program causing a computer to function as:

a determination unit configured to determine whether or not difference between left-eye image data and right-eye image data which constitute image data satisfies a threshold condition; and

an adjustment unit configured to adjust the image data in a manner that an angle of convergence become smaller in a case of stereoscopically displaying the image data, in a case where the determination unit determines that the difference satisfies the threshold condition,

wherein the adjustment unit adjusts the image data in a manner that respective pieces of image data become a same in movement amount of display positions in a depth direction perceived at a target point, the pieces of image data corresponding to a plurality of frames.

(14)

The program according to (13),

wherein the adjustment unit calculates the movement amount in a manner that extrusion amount of image data having a largest angle of convergence among the respective pieces of image data falls below a reference value.

(15)

The program according to (14),

wherein, as the threshold condition, the determination unit determines whether or not to satisfy a condition that extrusion amount according to the difference between the left-eye image data and the right-eye image data is greater than or equals to the reference value.

(16)

The program according to any one of (13) to (15), further causing the computer to function as:

a setting unit configured to set the threshold condition.

(17)

The program according to (16),

wherein the setting unit sets the threshold condition on the basis of continuous use time of a display device by a user of the display device, the display device performing display using the image data.

(18)

The program according to (16) or (17),

wherein the setting unit sets the threshold condition on the basis of an attribute of a user of a display device performing display using the image data.

### REFERENCE SIGNS LIST

100, 100′ display device
110 display unit
112 light-emitting unit
114 imaging unit
120 amount calculation unit
124, 126 adjustment-necessity determination unit
128 setting unit
132 display control unit
136 shutter control unit
140 infrared communication unit
144 analysis unit
148 variation-pattern storage unit
200 shutter glasses
212 right-eye image transparent unit
214 left-eye image transparent unit

1. An image processing device comprising:
a determination unit configured to determine whether or not difference between left-eye image data and right-eye image data which constitute image data satisfies a threshold condition; and
an adjustment unit configured to adjust the image data in a manner that an angle of convergence become smaller in a case of stereoscopically displaying the image data, in a case where the determination unit determines that the difference satisfies the threshold condition,
wherein the adjustment unit adjusts the image data in a manner that respective pieces of image data become a same in movement amount of display positions in a depth direction perceived at a target point, the pieces of image data corresponding to a plurality of frames.

2. The image processing device according to claim 1,
wherein the adjustment unit calculates the movement amount in a manner that extrusion amount of image data having a largest angle of convergence among the respective pieces of image data falls below a reference value.

3. The image processing device according to claim 2,
wherein, as the threshold condition, the determination unit determines whether or not to satisfy a condition that extrusion amount according to the difference between the left-eye image data and the right-eye image data is greater than or equals to the reference value.

4. The image processing device according to claim 1, further comprising:
a setting unit configured to set the threshold condition.

5. The image processing device according to claim 4,
wherein the setting unit sets the threshold condition on the basis of continuous use time of a display device by a user of the display device, the display device performing display using the image data.

6. The image processing device according to claim 5,
wherein the setting unit widens a range of the difference satisfying the threshold condition as the continuous use time becomes longer.

7. The image processing device according to claim 4,
wherein the setting unit sets the threshold condition on the basis of an attribute of a user of a display device performing display using the image data.

8. The image processing device according to claim 7,
wherein, in a case where the user is a child, the setting unit widens a range of the difference satisfying the threshold condition more than the range of the difference satisfying the threshold condition in a case where the user is an adult.

9. The image processing device according to claim 4,
wherein the setting unit sets the threshold condition in accordance with user operation.

10. The image processing device according to claim 1, further comprising:
a storage unit configured to store a specific variation pattern of the difference,
wherein the determination unit further determines whether or not a variation pattern of difference between left-eye image data and right-eye image data of target image data matches with the specific variation pattern stored in the storage unit, and
wherein the adjustment unit adjusts the image data in a case where the determination unit determines that the difference satisfies the threshold condition and determines that the variation pattern of the target image data matches with the specific variation pattern.

11. The image processing device according to claim 10, further comprising:
an analysis unit configured to analyze left-eye image data and right-eye image data of image data to which biological information of a user shows a specific reaction when stereoscopic display is performed, and then extract the specific variation pattern.

12. An image processing method comprising:
determining whether or not difference between left-eye image data and right-eye image data which constitute image data satisfies a threshold condition;
adjusting the image data in a manner that an angle of convergence become smaller in a case of stereoscopically displaying the image data, in a case where it is determined that the difference satisfies the threshold condition; and
adjusting the image data in a manner that respective pieces of image data become a same in movement amount of display positions in a depth direction perceived at a target point, the pieces of image data corresponding to a plurality of frames.

13. A program causing a computer to function as:
a determination unit configured to determine whether or not difference between left-eye image data and right-eye image data which constitute image data satisfies a threshold condition; and
an adjustment unit configured to adjust the image data in a manner that an angle of convergence become smaller in a case of stereoscopically displaying the image data, in a case where the determination unit determines that the difference satisfies the threshold condition,
wherein the adjustment unit adjusts the image data in a manner that respective pieces of image data become a same in movement amount of display positions in a depth direction perceived at a target point, the pieces of image data corresponding to a plurality of frames.

14. The program according to claim 13,
wherein the adjustment unit calculates the movement amount in a manner that extrusion amount of image data having a largest angle of convergence among the respective pieces of image data falls below a reference value.

15. The program according to claim 14,
wherein, as the threshold condition, the determination unit determines whether or not to satisfy a condition that extrusion amount according to the difference between the left-eye image data and the right-eye image data is greater than or equals to the reference value.

16. The program according to claim 13, further causing the computer to function as:
a setting unit configured to set the threshold condition.

17. The program according to claim 16,
wherein the setting unit sets the threshold condition on the basis of continuous use time of a display device by a user of the display device, the display device performing display using the image data.

18. The program according to claim 16,
wherein the setting unit sets the threshold condition on the basis of an attribute of a user of a display device performing display using the image data.
